(19) United States
(12) Patent Application Publication
(10) Pub. No.: US 2026/0034786 A1
(43) Pub. Date: Feb. 5, 2026

(54) Liquid Ejection Device

(71) Applicant: SEIKO EPSON CORPORATION, Tokyo (JP)

(72) Inventors: Eiji OSAWA, Matsumoto (JP); Chikara KOJIMA, Matsumoto (JP); Shingo TOMIMATSU, Shiojiri (JP); Masayoshi YAMADA, Shiojiri (JP)

(21) Appl. No.: 19/283,676

(22) Filed: Jul. 29, 2025

(30) Foreign Application Priority Data
Jul. 30, 2024 (JP) 2024-123408

(51) Int. Cl. B41J 2/165

(52) U.S. Cl. CPC B41J 2/16552; B41J 2/16505; B41J 2/16579; B41J 2002/16567

(57) ABSTRACT

A liquid ejection device 1 includes a head 10 including at least one nozzle 11 that ejects ejection liquid; a cap 20 that covers the nozzle 11 and that holds cleaning liquid 23 therein; and an ultrasonic device 25 that transmits ultrasonic waves 24 to the cleaning liquid 23, wherein the cleaning liquid 23 contacts the at least one nozzle 11 and the ultrasonic device 25 is arranged so as to be in contact with the cleaning liquid 23 in the cap 20.

The present application is based on, and claims priority from JP Application Serial Number 2024-123408, filed Jul. 30, 2024, the disclosure of which is hereby incorporated by reference herein in its entirety.

### BACKGROUND

### 1. Technical Field

The present disclosure relates to a liquid ejection device.

### 2. Related Art

In related art, a liquid ejection device is known in which an ultrasonic transducer is arranged on an outer surface of a cap that contacts an ejection head, and ultrasonic waves oscillated from the ultrasonic transducer are propagated to the cap to excite liquid in the cap, thereby cleaning ejection nozzles of the ejection head (refer to JP-A-2006-347000).

However, in the liquid ejection device including the above-described configuration, since ultrasonic waves are propagated through the cap, there is a problem in that the ultrasonic waves are reflected due to a difference in acoustic impedance between the cap and liquid, and the transmission intensity of the ultrasonic waves is reduced.

### SUMMARY

A liquid ejection device according to a first aspect of the present disclosure includes a head including at least one nozzle that ejects ejection liquid; a cap that covers the nozzle and that holds cleaning liquid therein; and an ultrasonic device that transmits ultrasonic waves to the cleaning liquid, wherein the cleaning liquid contacts the at least one nozzle and the ultrasonic device is arranged so as to be in contact with the cleaning liquid in the cap.

### BRIEF DESCRIPTION OF THE DRAWINGS

FIG. 1 is a cross-sectional view schematically showing a liquid ejection device according to an embodiment of the present disclosure.

FIG. 2 is a cross-sectional view schematically showing a liquid ejection device according to an other embodiment of the present disclosure.

FIG. 3 is a cross-sectional view showing a cross section of the liquid ejection device according to the other embodiment in an intersecting direction.

### DESCRIPTION OF EMBODIMENTS

Hereinafter, a liquid ejection device according to an embodiment of the present disclosure will be described.

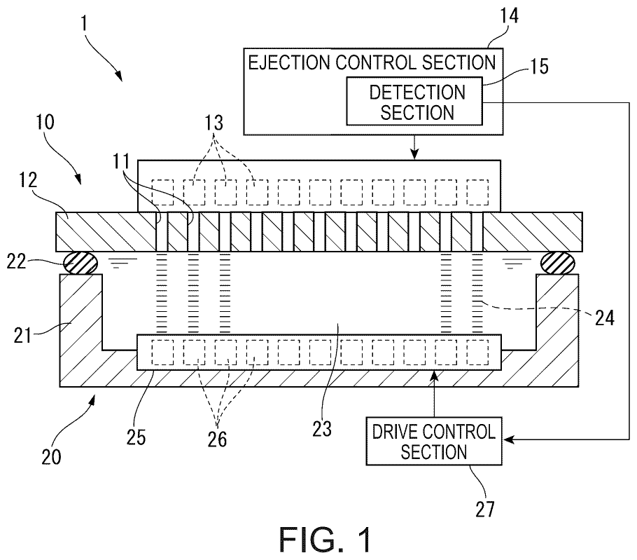

In FIG. 1, a liquid ejection device 1 includes a head 10 including a plurality of nozzles 11 for ejecting ejection liquid.

The head 10 includes a nozzle plate 12, and the plurality of nozzles 11 are formed in a row on the nozzle plate 12. A plurality of ejection sections 13 corresponding to each of the nozzles 11 are arranged on a rear side of the nozzle plate 12. The plurality of ejection sections 13 are connected to an ejection control section 14 installed outside the head 10, and pressure-feed ejection liquid to the corresponding nozzles 11 under the control of the ejection control section 14 to eject ejection liquid from the nozzles 11. As ejection liquid, ink for printing, a shaping material of a layering shaping device, or the like is used.

The ejection control section 14 includes a detector 15. The detector 15 monitors an ejection state of ejection liquid of each of the plurality of ejection sections 13, and can specify the ejection section 13 in which an ejection failure occurs and the corresponding nozzle 11. For example, the detector 15 can detect flow path narrowing or clogging of the nozzle 11 by detecting the ejection resistance from pressure fluctuation or the flow speed at the time of ejection for each nozzle 11. By this, the detector 15 can detect the nozzle 11 having an ejection failure as an abnormal nozzle.

The liquid ejection device 1 includes a cap 20 that collectively covers the plurality of nozzles 11. The cap 20 covers the nozzles 11 when the head 10 is not in use or during a cleaning operation, and can be separated from a front surface of the head 10 when the head 10 is in use to eject ejection liquid from the nozzles 11.

The cap 20 includes a cap main body 21 that covers a surface of the nozzle plate 12.

The cap main body 21 has a recess shape on a side facing the nozzle plate 12, and an annular rubber packing 22 is provided around the raised periphery. The rubber packing 22 is arranged in a state of surrounding all of the plurality of nozzles 11, and is capable of sealing liquid by being in close contact with a surface of the nozzle plate 12 over the entire circumference. The rubber packing 22 constitutes a flexible member at a position of the cap 20 that contacts the head 10.

As the flexible member, a natural or synthetic rubber material, other resin materials, and the like such as an elastomer can be used, and it is desirable to appropriately select a material capable of ensuring the sealing property between the nozzle plate 12 and the cap main body 21.

The inside of the cap main body 21 is a closed space sealed by the rubber packing 22, and cleaning liquid 23 is held in this space.

The cleaning liquid 23 is liquid suitable for cleaning the nozzle 11, and for example, a solvent for ejection liquid such as printing ink can be used, and pure water or the ejection liquid itself may be used as the cleaning liquid 23.

The cleaning liquid 23 is filled in the cap main body 21 in a sufficient amount, and the plurality of nozzles 11 are immersed in the cleaning liquid 23.

An ultrasonic device 25 that transmits ultrasonic waves 24 to the cleaning liquid 23 is installed on a bottom surface of a recess section of the cap main body 21. The ultrasonic device 25 is arranged so as to be in contact with the cleaning liquid 23 in the cap main body 21.

The ultrasonic device 25 has an array shape in which a plurality of ultrasonic elements 26 such as piezoelectric elements are arranged vertically and horizontally. As such an ultrasonic device 25, for example, a configuration in which a substrate including openings in a two dimensional array, a diaphragm that closes the openings of the substrate, and piezoelectric elements arranged at positions corresponding to the respective openings of the diaphragm can be exemplified. In this case, a region of the diaphragm that closes one opening is set as a vibration section, and one ultrasonic element 26 (thin film type ultrasonic element) is configured by one vibration section and the piezoelectric element arranged in the vibration section.

As a unit for fixing the ultrasonic device 25 to a bottom surface of a recess section of the cap main body 21, a mechanical unit such as fitting, adhesion, or other unit may be used.

A drive controller 27 is connected to the ultrasonic device 25.

The drive controller 27 individually drives the plurality of ultrasonic elements 26 and transmits the ultrasonic waves 24 to the cleaning liquid 23.

The plurality of ultrasonic elements 26 may be installed in a one-to-one correspondence with the plurality of nozzles 11, and the plurality of ultrasonic elements 26 may correspond to one nozzle 11 or one ultrasonic element 26 may correspond to the plurality of nozzles 11. For example, the ultrasonic waves 24 from the respective ultrasonic elements 26 can be focused on one nozzle 11 by a delay control of the ultrasonic waves 24 with respect to the plurality of ultrasonic elements 26. By this, the intensity of the ultrasonic wave 24 acting on one nozzle 11 can be secured, and the ultrasonic wave 24 can be selectively transmitted to the specific nozzle 11. By changing the setting of the delay control, the nozzle 11 to focus the ultrasonic waves 24 can be changed to another nozzle 11.

The drive controller 27 can clean all the nozzles 11 by transmitting the ultrasonic waves 24 from the plurality of ultrasonic elements 26.

Here, assuming that drive frequency of the ultrasonic device 25 is f (MHz) and a diameter of the nozzle 11 is D (μm), the drive controller 27 can drive the ultrasonic element 26 so as to satisfy a formula of f>6/D.

Generally, in nozzle cleaning using ultrasonic waves, there is a problem that cavitation occurs in the entire cleaning liquid depending on frequency of ultrasonic waves, particularly when the frequency is low, and selective nozzle cleaning cannot be performed, resulting in uneven cleaning. In contrast, by setting the formula of f>6/D, the bubble size generated by cavitation becomes small, and a nozzle surface can be efficiently cleaned by ultrasonic cleaning.

The above-described formula of f>6/D is derived as follows.

Bubble generated as cavitation has a resonance frequency fo and a bubble radius ro that have a relationship of the following formula.

$$fo = ( 1 / 2 Π ro ) \times √ ( 3 γ Po / ρ )$$

Po: static pressure, γ: heat capacity ratio of gas to be bubbles ρ: density of liquid
Here, assuming that Po=1 atm, and liquid is water (p=1 g/cm\hat{ }3), fo×ro^{˜}3 (“˜” represents approximation, the same applies hereinafter),
further, when diameter Ro=2ro is substituted,

$$fo \times {Ro}^{\sim} 6 ,$$

in order for a bubble having the diameter Ro to be able to enter a nozzle having a nozzle diameter D, D>Ro is required, and assuming that resonance frequency f of the ultrasonic element is set to fo, f×D>fo×Ro^{˜}6, thus f×D>6, leading to f>6/D.

As described above, when frequency of ultrasonic waves is f>6/D, bubbles having a small diameter can be made to enter a nozzle, and thus, cavitation over the entire cleaning liquid can be suppressed, and selectively cleaning the nozzle can be performed using the cavitation in the form of small bubbles, and as a result, uneven cleaning with respect to the nozzle can be eliminated.

The drive controller 27 can clean all the nozzles 11 by transmitting the ultrasonic waves 24 from the ultrasonic elements 26.

Further, the drive controller 27 can select the nozzle 11 to be cleaned by referring to a detection result of the detector 15.

In the detector 15, in a case where any of the plurality of nozzles 11 has an ejection failure and is detected as an abnormal nozzle, the drive controller 27 selects the ultrasonic element 26 corresponding to the nozzle 11 determined as the abnormal nozzle by the detector 15, and drives the ultrasonic element 26 such that the ultrasonic waves 24 are focused toward the nozzle 11 determined as the abnormal nozzle. By this, the ultrasonic waves 24 are focused on the nozzle 11 having an ejection failure, and thus local nozzle cleaning can be performed.

### Operational Effects of Present Embodiment

The liquid ejection device 1 of the present embodiment includes the head 10 including the plurality of nozzles 11 that eject ejection liquid, the cap 20 that covers the plurality of nozzles 11 and holds the cleaning liquid 23 therein, and the ultrasonic device 25 that transmits the ultrasonic waves 24 to the cleaning liquid 23, the cleaning liquid 23 contacts the plurality of nozzles 11, and the ultrasonic device 25 is arranged so as to be in contact with the cleaning liquid 23 in the cap 20.

By this, all the nozzles 11 are covered with the cap 20, and the cleaning liquid 23 held in the cap 20 is brought into contact with the nozzles 11. The ultrasonic device 25 is arranged so as to be in contact with the cleaning liquid 23 in the cap 20, and the ultrasonic waves 24 transmitted from the ultrasonic device 25 are directly transmitted from the ultrasonic device 25 to the cleaning liquid 23, so that the transmittance of the ultrasonic waves 24 reaching the cleaning liquid 23 is improved. By this, the ultrasonic waves 24 transmitted to the cleaning liquid 23 is strengthened, and bubble-like cavitation is sufficiently generated in the cleaning liquid 23, so that the cleaning effect on the nozzle 11 can be enhanced.

In the liquid ejection device 1 of the present embodiment, assuming that drive frequency of the ultrasonic device 25 by the drive controller 27 is f (MHz) and a diameter of the nozzle is D (μm), the formula of f>6/D is satisfied.

Thus, the bubble size due to cavitation generated in the cleaning liquid 23 by the ultrasonic waves 24 from the ultrasonic device 25 is reduced, and the bubbles having a small diameter can be made to enter the nozzle 11, and ultrasonic cleaning can be efficiently performed up to an inner surface of the nozzle 11.

In the liquid ejection device 1 of the present embodiment, the ultrasonic device 25 includes the plurality of ultrasonic elements 26.

By this, by individually controlling the transmission of the ultrasonic waves 24 by each of the plurality of ultrasonic elements 26, it is possible to transmit the ultrasonic waves 24 not to the entire ultrasonic device 25 but to a partial or local portion of the ultrasonic device 25.

The liquid ejection device 1 of the present embodiment includes the drive controller 27 that controls the drive of the plurality of ultrasonic elements 26, and the drive controller 27 selectively drives each of the plurality of ultrasonic elements 26 so as to focus the ultrasonic waves 24 on positions of the nozzles 11.

By this, bubble-like cavitation is locally generated around the nozzle 11 by the ultrasonic waves 24 focused on the nozzle 11, and an efficient cleaning effect is obtained.

The liquid ejection device 1 of the present embodiment includes the detector 15 that detects the nozzle 11 having an ejection failure as an abnormal nozzle, and the drive controller 27 drives the plurality of ultrasonic elements 26 so that the ultrasonic waves 24 are focused toward the nozzle 11 detected as an abnormal nozzle by the detector 15.

By this, the ultrasonic waves 24 are focused on the nozzle 11 having the ejection failure, and thus it is possible to further improve the effectiveness of local nozzle cleaning.

In the liquid ejection device 1 of the present embodiment, the rubber packing 22 having flexibility is arranged at a position of the cap 20 in contact with the head 10.

By this, the cap 20 and the head 10 are brought into contact with each other via the rubber packing 22 having flexibility, and the protection of a nozzle surface of the head 10 can be improved while improving the sealing property of the cleaning liquid 23.

### Other Embodiment

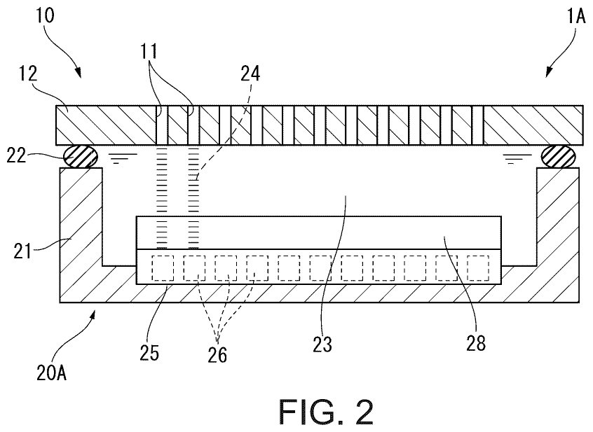

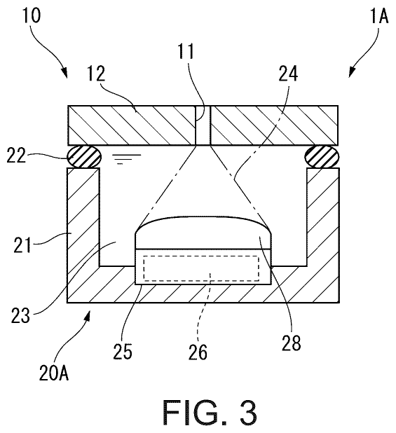

FIGS. 2 and 3 show an other embodiment of the present disclosure.

A liquid ejection device 1A of the present embodiment basically includes the same configuration as that of the liquid ejection device 1 of FIG. 1 described above. Therefore, the description of the common configuration will be omitted, and the different configuration will be described below.

In the embodiment of FIG. 1 described above, a surface of the ultrasonic device 25 is directly immersed in the cleaning liquid 23. In contrast, in the liquid ejection device 1A of the present embodiment shown in FIG. 2, an acoustic lens 28 is installed on a surface of the ultrasonic device 25, that is, a transmission surface of the ultrasonic waves 24 in a cap 20A. Note that the acoustic lens 28 may be made of a material similar to that of a general ultrasonic probe, for example, silicone having an acoustic impedance close to that of water.

In FIG. 3, the acoustic lens 28 has a “D” shape in a cross-sectional shape in a direction intersecting an arrangement direction of the plurality of nozzles 11, that is, an arrangement direction of the ultrasonic elements 26.

In FIG. 2, the acoustic lens 28 has the above-described cross-sectional shape that is continuous along the arrangement direction of the plurality of nozzles 11, and has a length over the entire length of the ultrasonic device 25 in the same direction.

In the ultrasonic device 25 in which the acoustic lens 28 is installed, the ultrasonic waves 24 from the ultrasonic element 26 is transmitted to the corresponding nozzle 11 under the control of the drive controller 27. On the other hand, in a direction intersecting the arrangement of the plurality of nozzles 11, the ultrasonic waves 24 from the ultrasonic element 26 extending in a width direction of the ultrasonic device 25 is deflected by the acoustic lens 28 and is focused on the corresponding nozzle 11.

As described above, in the present embodiment, the ultrasonic device 25 includes the acoustic lens 28 arranged on a transmission surface from which the ultrasonic waves 24 are transmitted.

By this, the ultrasonic waves 24 transmitted from the ultrasonic device 25 can be deflected by the acoustic lens 28, and the function of focusing the ultrasonic waves 24 on the nozzle 11 can be enhanced.

That is, in the liquid ejection device 1A of the present embodiment, even the ultrasonic waves 24 that cannot be introduced into the nozzle 11 in a state where the acoustic lens 28 is not provided can be introduced into the nozzle 11 that is focused by the acoustic lens 28, and the efficiency of cleaning the nozzle 11 can be improved.

### Modifications

The disclosure is not limited to the above-described embodiment, and configurations obtained by modifications, improvements, and the like within a range in which the object of the disclosure can be achieved are included in the disclosure.

In the above-described embodiment, an array in which the plurality of ultrasonic elements 26 (thin film type ultrasonic elements) are arranged vertically and horizontally is used as the ultrasonic device 25, but a so-called bulk type ultrasonic element that vibrates by itself by application of a drive voltage and transmits ultrasonic waves may be used as the ultrasonic element 26. In a case where such a bulk type ultrasonic element is used as the ultrasonic element 26, the ultrasonic elements may be arranged in one or two rows along the arrangement of the nozzles 11. In this case, two or more ultrasonic elements 26 corresponding to the same nozzle 11 may be operated simultaneously in parallel, or may be operated individually. The acoustic lens 28 may be utilized to focus the ultrasonic waves 24 from two or more rows of ultrasonic elements 26 into a single row of nozzles 11. When the nozzles 11 are arranged in a plurality of rows, one row of the ultrasonic elements 26 may correspond to the plurality of rows.

### Outline of Present Disclosure

A liquid ejection device according to a first aspect of the present disclosure includes a head including at least one nozzle that ejects ejection liquid; a cap that covers the nozzle and that holds cleaning liquid therein; and an ultrasonic device that transmits ultrasonic waves to the cleaning liquid, wherein the cleaning liquid contacts the at least one nozzle and the ultrasonic device is arranged so as to be in contact with the cleaning liquid in the cap.

By this, the nozzle is covered with the cap, and the cleaning liquid held in the cap is brought into contact with the nozzle. The ultrasonic device is arranged so as to be in contact with the cleaning liquid in the cap, and the ultrasonic waves transmitted from the ultrasonic device are directly transmitted from the ultrasonic device to the cleaning liquid, so that the transmittance of the ultrasonic waves reaching the cleaning liquid is improved. By this, the ultrasonic waves transmitted to the cleaning liquid are strengthened, and bubble-like cavitation is sufficiently generated in the cleaning liquid, so that the cleaning effect on the nozzle can be enhanced.

The liquid ejection device of the present aspect is configured such that assuming that drive frequency of the ultrasonic device is f (MHz) and a diameter of the nozzle is D (μm), a formula of f>6/D is satisfied.

In nozzle cleaning using ultrasonic waves, there is a problem that cavitation occurs in the entire cleaning liquid depending on frequency of ultrasonic waves, particularly when the frequency is low, and selective nozzle cleaning cannot be performed, resulting in uneven cleaning. In contrast, by setting the formula of f>6/D, the bubble size generated by cavitation becomes small, and a nozzle surface can be efficiently cleaned by ultrasonic cleaning.

The above-described formula of f>6/D is derived as follows.

Bubble generated as cavitation has a resonance frequency fo and a bubble radius ro that have a relationship of the following formula.

$$fo = ( 1 / 2 Π ro ) \times √ ( 3 γ Po / ρ )$$

Po: static pressure, γ: heat capacity ratio of gas to be bubbles ρ: density of liquid
Here, assuming that Po=1 atm, and liquid is water (p=1 g/cm\hat{ }3), fo×ro^{˜}3 (“˜” represents approximation, the same applies hereinafter),
further, when diameter Ro=2ro is substituted,

$$fo \times {Ro}^{\sim} 6 ,$$

in order for a bubble having the diameter Ro to be able to enter a nozzle having a nozzle diameter D, D>Ro is required, and assuming that resonance frequency f of the ultrasonic element is set to fo, f×D>fo×Ro^{˜}6, thus f×D>6, leading to f>6/D.

As described above, when frequency of ultrasonic waves is f>6/D, bubbles having a small diameter can be made to enter a nozzle, and thus, cavitation over the entire cleaning liquid can be suppressed, and selectively cleaning the nozzle can be performed using the cavitation in the form of small bubbles, and as a result, uneven cleaning with respect to the nozzle can be eliminated.

The liquid ejection device of the present aspect is configured such that the ultrasonic device includes a plurality of ultrasonic elements.

By this, by individually controlling the transmission of the ultrasonic waves by each of the plurality of ultrasonic elements, it is possible to perform the transmission of the ultrasonic waves not to the entire ultrasonic device but to a partial or local portion.

The liquid ejection device of the present aspect is configured such that the liquid ejection device further includes a drive controller that controls drive of the plurality of ultrasonic elements, wherein the drive controller selectively drives each of the plurality of ultrasonic elements so as to focus the ultrasonic waves on positions of the nozzles.

By this, bubble-like cavitation is locally generated around the nozzle by the ultrasonic waves focused on the nozzle, and the efficient cleaning effect is obtained.

The liquid ejection device of the present aspect is configured such that the liquid ejection device further includes a detector that detects an abnormal nozzle that is the nozzle having an ejection failure, wherein the drive controller drives the plurality of ultrasonic elements so that the ultrasonic waves are focused toward the abnormal nozzle detected by the detector.

By this, the ultrasonic waves are focused on the nozzle having an ejection failure, and thus it is possible to further improve the effectiveness of local nozzle cleaning.

The liquid ejection device of the present aspect is configured such that in the ultrasonic device, an acoustic lens is arranged on a transmission surface through which the ultrasonic waves are transmitted.

By this, the ultrasonic waves transmitted from the ultrasonic device can be deflected by the acoustic lens, and the function of focusing the ultrasonic waves on the nozzle can be enhanced.

The liquid ejection device of the present aspect is configured such that a flexible member is arranged at a position of the cap in contact with the head.

By this, the cap and the head are in contact with each other via the flexible member, for example, a rubber packing, and it is possible to improve the protection of a nozzle surface of the head while improving the sealing property of the cleaning liquid.

What is claimed is:

1. A liquid ejection device comprising:
a head including at least one nozzle that ejects ejection liquid;
a cap that covers the nozzle and that holds cleaning liquid therein; and
an ultrasonic device that transmits ultrasonic waves to the cleaning liquid, wherein
the cleaning liquid contacts the at least one nozzle and
the ultrasonic device is arranged so as to be in contact with the cleaning liquid in the cap.

2. The liquid ejection device according to claim 1, wherein
drive frequency of the ultrasonic device f (MHz) and a diameter of the nozzle is D (μm) satisfy a formula of f>6/D.

3. The liquid ejection device according to claim 1, wherein
the ultrasonic device includes a plurality of ultrasonic elements.

4. The liquid ejection device according to claim 3, further comprising:
a drive controller that controls drive of the plurality of ultrasonic elements, wherein
the drive controller selectively drives each of the plurality of ultrasonic elements so as to focus the ultrasonic waves on positions of the nozzles.

5. The liquid ejection device according to claim 4, further comprising:
a detector that detects an abnormal nozzle that is the nozzle having an ejection failure, wherein
the drive controller drives the plurality of ultrasonic elements so that the ultrasonic waves are focused on the abnormal nozzle detected by the detector.

6. The liquid ejection device according to claim 1, wherein
in the ultrasonic device, an acoustic lens is arranged on a transmission surface through which the ultrasonic waves are transmitted.

7. The liquid ejection device according to claim 1, wherein
an elastomer is arranged at a position of the cap in contact with the head.
